(19) United States
(12) Patent Application Publication
(10) Pub. No.: US 2021/0264524 A1
(43) Pub. Date: Aug. 26, 2021

(54) AUTOMATICALLY GENERATING PERSONAL ARTICLES INSURANCE DATA BASED ON DIGITAL IMAGES

(71) Applicant: STATE FARM MUTUAL AUTOMOBILE INSURANCE COMPANY, BLOOMINGTON, IL (US)

(72) Inventors: KATHRYN E. KNARR, BLOOMINGTON, IL (US); DWAYNE TAYLOR, BLOOMINGTON, IL (US); AMY ENGELHORN, NORMAL, IL (US)

(21) Appl. No.: 14/996,819

(22) Filed: Jan. 15, 2016

Related U.S. Application Data
(60) Provisional application No. 62/105,975, filed on Jan. 21, 2015.
(60) Provisional application No. 62/145,557, filed on Apr. 10, 2015.

(51) Int. Cl. G06Q 40/08; G06K 9/00; G06K 9/72

(52) U.S. Cl. CPC G06Q 40/08; G06K 9/72; G06K 9/00469

(57) ABSTRACT

The present disclosure generally relates to methods and systems to automatically generate personal articles insurance data and/or personal articles insurance policies, quotes, premiums, pricing, discounts, etc. More particularly, the present disclosure relates to automatically generating personal articles insurance data based upon information extracted from digital images of documentation associated with a personal article, such as via object recognition and/or optical character recognition techniques. The digital images of documentation of the personal article may include digital images of alpha-numeric text related to the personal article and/or at least one picture of the personal article. Personal articles insurance quotes, policies, premiums, discounts, etc. may then be generated, such as via a remote insurance provider server, and transmitted and/or presented to a customer for review, such as via wireless communication or data transmission from the remote insurance provider server to the customer's mobile device for their review, approval, and/or modification.

### CROSS REFERENCE TO RELATED APPLICATION

This application claims priority, under 35 U.S.C. § 119(b), to U.S. Provisional Patent Application Ser. No. 62/105,975, filed on Jan. 21, 2015, entitled Methods and Systems to Automatically Generate Personal Articles Insurance Data Based Upon Digital Images of Documentation Associated with the Personal Articles, and U.S. Provisional Patent Application Ser. No. 62/145,557, filed on Apr. 10, 2015, entitled Methods and Systems to Automatically Generate Personal Articles Insurance Data Based Upon Digital Images of Documentation Associated with the Personal Articles, the entire disclosures of which are incorporated herein by reference.

### TECHNICAL FIELD

The present disclosure generally relates to methods and systems to automatically generate personal articles insurance data and/or insurance policies, quotes, or pricing. More particularly, the present disclosure relates to automatically generating personal articles insurance data and/or insurance policies, quotes, or pricing, and/or handling insurance claims, based upon information extracted from digital images of documentation associated with one or more personal articles.

### BACKGROUND

Personal articles insurance policies provide coverage for a wide variety of items including: jewelry, furs, cameras, musical instruments, sports equipment, computer equipment, guns, knives, tools, artwork, mobile telephones, toys, antiques, etc. Currently, insurance customers may not be able to obtain a quote for, or purchase a personal articles insurance policy, without assistance from an insurance provider, such as an insurance agent or insurance company representative.

Some insurance representatives or agents may use a .pdf solution during current personal articles insurance underwriting processes. For example, a .pdf may be completed, photos of a personal article may be obtained, and supporting documentation associated with the personal article may be attached. However, due to current .pdf limitations, and the nature of the broad coverage provided under a personal articles insurance policy, closer review is required by underwriting (i.e., it is important to capture a detailed description of the personal article(s) and properly classify each personal article in order to collect the appropriate insurance premium for the associated exposure).

Further, unlike other enterprise application (EA) solutions (e.g., renters insurance, condo insurance, homeowners insurance, etc.), a current personal article policy (PAP) .pdf processes may not connect to an insurance policy application decision support knowledge based system (KBA). As a result, the PAP .pdf processes, or other conventional techniques, may not be automatically pre-screened to identify areas that require underwriting/service review. In addition, available information within a PAP .pdf, or other conventional documents, may be insufficient for interactive fire streaming purposes.

Automated streamlined transactions (ASTs) are written programs that may be used to automate human interaction with fire systems and provide the ability to process a high volume of items with significant speed and accuracy. The EA .pdf AST was developed to identify information on a .pdf application and stream it into the appropriate fields. The personal articles policy data being streamed (name, address, etc.) is not presently sufficient to automate the application, and not intended to verify that the information entered on the application is correct. Rather, insurance agents and/or underwriting associates must manually verify that personal articles data is accurate and appropriate for personal articles insurance policy issuance.

### SUMMARY

The Systems and methods are provided that may automatically extract personal article information from digital images of documentation of a personal article and/or from digital images of the personal article itself. For instance, digital or other Object Recognition (OR) and/or OCR (Optical Character Recognition) techniques may be performed on digital or other images of the personal articles and/or associated documentation (such as an owner's or user's manual). The systems and methods may automatically generate personal articles insurance policy data and/or personal articles insurance policies, premiums, discounts, quotes, risk level analysis, and/or pricing based upon personal article information automatically extracted from digital images of documentation of one or more personal articles and/or from digital images of the personal articles themselves.

In one aspect, a computer implemented method for automatically generating personal articles insurance data and/or insurance policies or quotes may be provided. The method may include (1) receiving, at a processor of a computing device, digital image data from an electronic device, in response to the processor executing a digital image data receiving module, wherein the digital image data may be representative of documentation for at least one personal article. The method may include (2) generating, using a processor of a computing device, personal article information data and/or a personal articles insurance policy (or quote, premium, rate, discount, risk, etc.), based upon the digital image data, in response to the processor executing a personal articles information data recognition module. In one embodiment, the personal articles information data may be representative of identifying characteristics of the at least one personal article. The method may also include (3) generating, using a processor of a computing device, personal articles insurance data and/or a personal articles insurance policy (or quote, premium, rate, discount, risk, etc.), based upon the personal articles information data, in response to the processor executing a personal articles insurance data generation module. The method may include additional, fewer, or alternate actions, including those discussed elsewhere herein.

In another aspect, a system for automatically generating personal articles insurance data and/or insurance policies or quotes may be provided. The system may include a digital image data receiving module stored on a memory that, when executed by a processor of a computing device, causes the processor to receive digital image data from an electronic device, wherein the digital image data may be representative of documentation for at least one personal article. The system may further include a personal articles information recognition module stored on a memory that, when executed by a processor of a computing device, causes the processor to generate personal articles information data and/or a personal articles insurance policy (or quote, premium, rate, discount, risk, etc.), based upon the digital image data. In one embodiment, the personal articles information data may be representative of identifying characteristics of the at least one personal article. The system may also include a personal articles insurance data generation module stored on a memory that, when executed by a processor of a computing device, may cause the processor to generate personal articles insurance data and/or insurance policies, quotes, premiums, rates, discounts, etc. based upon the personal articles information data. The system may include additional, fewer, or alternate functionality, including that discussed elsewhere herein.

In another aspect, a non-transitory computer-readable medium storing instructions that, when executed by a processor of a computing device, may cause the processor to automatically generate personal articles insurance data and/or insurance policies/quotes. The processor and/or instructions may include a digital image data receiving module that, when executed by a processor of a computing device, causes the processor to receive digital image data from an electronic device, wherein the digital image data may be representative of documentation for at least one personal article. The non-transitory computer-readable medium may further include a personal articles information recognition module that, when executed by a processor of a computing device, causes the processor to generate personal articles information data and/or a personal articles insurance policy (or quote, premium, rate, discount, risk, etc.), based upon the digital image data. The personal articles information data may be representative of identifying characteristics of the at least one personal article. The non-transitory computer-readable medium may also include a personal articles insurance data generation module that, when executed by a processor of a computing device, causes the processor to generate personal articles insurance data and/or an insurance policy, quote, premium, rate, discount, etc. based upon the personal articles information data.

Advantages will become more apparent to those skilled in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### BRIEF DESCRIPTION OF THE DRAWINGS

The Figures described below depict various aspects of the systems and methods disclosed herein. It should be understood that each Figure depicts an embodiment of a particular aspect of the disclosed systems and methods, and that each of the Figures is intended to accord with a possible embodiment thereof. Further, wherever possible, the following description refers to the reference numerals included in the following Figures, in which features depicted in multiple Figures are designated with consistent reference numerals.

There are shown in the drawings arrangements which are presently discussed, it being understood, however, that the present embodiments are not limited to the precise arrangements and instrumentalities shown, wherein:

FIG. 1 depicts a high-level block diagram for an exemplary computer system for automatically generating personal articles insurance data;

FIG. 2 depicts a block diagram for an exemplary client device for automatically generating personal articles insurance data;

FIG. 3 depicts a block diagram for an exemplary remote computing device for automatically generating personal articles insurance data;

FIG. 4 depicts a flow diagram for an exemplary method for automatically generating personal articles insurance data;

FIG. 5 depicts a flow diagram for an exemplary method for automatically generating personal articles insurance data;

FIG. 6 depicts a flow diagram for an exemplary method for automatically generating personal articles insurance data;

FIG. 7 depicts a flow diagram for an exemplary method for automatically generating personal articles insurance data and/or handling insurance claims; and

FIG. 8 depicts a flow diagram for an exemplary method for automatically generating personal articles insurance data and/or building inventory lists.

The Figures depict preferred embodiments for purposes of illustration only. One skilled in the art will readily recognize from the following discussion that alternative embodiments of the systems and methods illustrated herein may be employed without departing from the principles of the invention described herein.

### DETAILED DESCRIPTION

The systems and methods of the present disclosure allow customers to utilize a digital photograph of a personal article, an associated purchase receipt and/or an associated appraisal to receive a quote for, and/or to purchase, a personal articles insurance policy online. The systems and methods of the present disclosure may include an online personal articles insurance policy application that allows for quick purchase of a personal articles insurance policy that may enable an insurance customer to submit a photo of the personal article(s), a photo of an associated appraisal of the personal article(s), or other acceptable documentation, and/or answer a few questions based upon the type of personal article(s). The methods and systems may collect information regarding a personal article to support use of automated streaming transactions, allowing automation of an application, and/or verification that the information entered on the application is correct. The systems and methods may provide additional value added solutions, from available information, which benefit an insurance provider and an associated insurance customer.

The methods and systems may include a unique combination of processes and technology, based upon, for example, an object recognition (OR) algorithm (and/or optical character recognition (OCR) algorithm) that automatically identifies a personal article using at least one digital image of the personal article. For example, a personal article category (e.g., jewelry, computers, tools, firearms, etc.) may be determined by using an object recognition algorithm to process at least one digital image of the personal article. The methods and systems may automatically identify at least one document (e.g., an appraisal, a purchase receipt, etc.) associated with a personal article using, for example, an optical character recognition (OCR) algorithm.

The methods and systems may validate that, for example, an appraisal matches an associated personal article. The methods and systems may validate that a personal article is authentic. An object or optical character recognition technique may automatically identify data attributes contained within document(s) associated with a personal article. The systems and methods may collect data (e.g., appraisal dates, quality measures, dollar amounts, etc.) associated with a personal article. Metadata may be extracted from data that is representative of at least one digital image of a personal article, and may be collected for potential use in data pre-population, underwriting, fraud detection, etc. Date/time stamps, geo-tags, etc. may also be extracted from data that is representative of at least one digital image of a personal article. The methods and systems may include processes that pre-populate the extracted data into workflows.

The methods and systems may trigger a presence and/or an absence of questions to include within an insurance application. For example, if a personal article is determined to be categorized as jewelry, a question related to whether the personal article (e.g., jewelry) is kept in a safe or vault. If the jewelry is indicated to be kept in a safe or a vault, a further question may be included inquiring as to how long the jewelry is kept in the safe or vault. An additional question may inquire as to whether the jewelry is item gem-printed, and/or whether the jewelry is Gemological Institution of America (GIA) or European Gemological Laboratory (EGL) certified. A further question may inquire as to whether insurance coverage is desired when a personal article is unattended. Another question may inquire as to whether the personal article is for professional and/or non-professional use.

The methods and systems may automatically cross validate personal article documents (e.g., an appraisal) with at least on digital image of the personal article. Multiple digital images of the personal article (e.g., a front, a back, a side, or sections) may be analyzed to verify authenticity of the personal article. Attributes of a personal article may be validated for fraud prevention (e.g., use of internet photos may be detected, data on a picture (e.g., an online image or a real-time digital image) may be determined to be prior to a date on a purchase receipt, prior submission of a same photo of a personal article may be detected, a geo-tagged location may be determined to differ greatly from an insurance customer location during a time of purchase, etc.). Automation of common procedures, triggered by customers' seeking to insure personal articles, may reduce computer processing times, memory requirements and/or related facilities. Using the methods and systems, insurance customers may be navigated through consistent processes, focused on relevant information to insure personal articles, and the processes may be correlated with impacts to the insurance customer and related agreement information.

Thresholds for purchasing, binding, inspecting, and underwriter reviews may be included within a personal articles insurance application process. Potential insurance discounts may be determined based upon answers to certain questions (e.g., an alarm certificate). The systems and methods may identify a prior insurance claim related to a personal article. The systems and methods may provide data for other uses (e.g., to determine prior use of photo(s), to determine prior use of receipts, to cross sell insurance products, to create a personal inventory content, for insurance financial reviews, to process insurance claims, etc.).

### Exemplary System for Automatically Generating Personal Articles Insurance Data

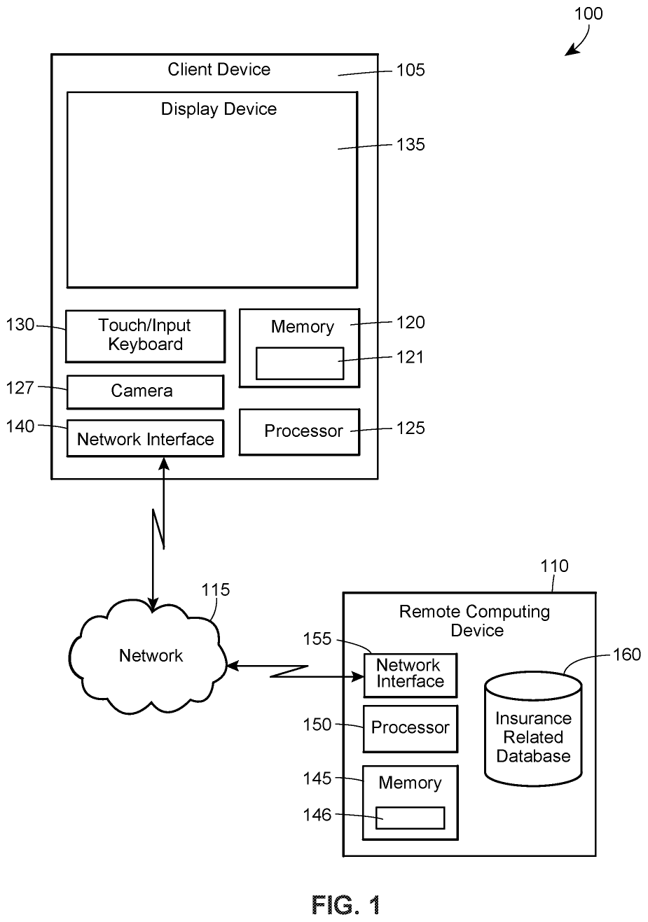

Turning to FIG. 1, a computer system for generating personal articles insurance data (and/personal articles insurance policies, quotes, pricing, etc.) based upon digital images 100 may include a client device 105 in communication with a remote computer device (e.g., a server) 110 via a network 115. The computer system 100 may implement communications between the client device 105 and the remote computing device 105 (e.g., a remote server) to provide, for example, digital image data to an insurance related database 160. For example, the computer system 100 may acquire digital image data from, for example, a user of a client or mobile device 105 (e.g., a smart phone, a digital camera, smart watch, smart glasses, wearable electronics, laptop, etc.). As described in detail herein, the computer system 100 may automatically generate personal articles insurance data based upon, for example, information extracted from digital images.

For clarity, only one client device 105 is depicted in FIG. 1. While FIG. 1 depicts only one client device 100, it should be understood that any number of client devices 100 may be supported and that each client device 100 may be any appropriate computing or mobile device, such as a mobile telephone, a personal data assistant, a tablet or a lap-top computer having a digital camera 127. A client device 105 may include a memory 120 and a processor 125 for storing and executing, respectively, a module 121. The module 121, stored in the memory 120 as a set of computer-readable instructions, may be related to an application for generating personal articles insurance data based upon digital images that, when executed on a processor 125, causes data representative of personal article characteristics based upon digital images to be stored in the memory 120. As described in detail herein, the module 121 may facilitate interaction between an associated client device 105 and a remote computing device 110. The processor 125, further executing the module 121, may facilitate communications between a remote computing device 110 and a client device 105 via a network interface 140 and a network 115.

A client or mobile device 105 may include a display device 135 which may be any type of electronic display device, such as a liquid crystal display (LCD), a light emitting diode (LED) display, a plasma display, a cathode ray tube (CRT) display, or any other type of known or suitable electronic display. A display device 135 may exhibit a display which depicts a user interface for configuring a client device 105 to communicate with a remote computing device 110. A client device 105 may include a user input device 130, such as a touch input/keyboard/pointing device (e.g., a mouse) that provides a mechanism for a user of the client device 105 to launch a client device insurance application and, for example, to interact with a system for generating personal articles insurance data (and/or personal articles insurance policies, quotes, pricing, discounts, etc.) based upon digital images. The user input device 130 may be configured as an integral part of a display device 135, such as a touch screen display device.

The network interface 140 may be configured to facilitate communications between a client device 105 and a remote computing device 110 via any wireless communication network 115, including for example a wireless LAN, MAN or WAN, WiFi, the Internet, or any combination thereof. Moreover, a client device 105 may be communicatively connected to a remote computing device 110 via any suitable communication system, such as via any publicly available or privately owned communication network, including those that use wireless communication structures, such as wireless communication networks, including for example, wireless LANs and WANs, satellite and cellular telephone communication systems, etc. A client device 105 may cause, for example, digital image data and/or manual answer data to be transmitted to, and stored in, for example, a remote server 110, memory 145, and/or a remote insurance related database 160.

A remote computing device 110 may include a memory 145 and a processor 150 for storing and executing, respectively, a module 146. The module 146, stored in the memory 145 as a set of computer-readable instructions, may facilitate applications related to generating personal articles insurance data based upon digital images. The module 146 may also facilitate communications between the remote computing device 110 and a client device 105 via a network interface 155 and the network 115, and other functions and instructions.

A remote computing device 110 may be communicatively coupled to an insurance related database 160. While the insurance related database 160 is shown in FIG. 1 as being communicatively coupled to the remote computing device 110, it should be understood that the insurance related database 160 may be located within separate remote servers (or any other suitable computing devices) communicatively coupled to the remote computing device 110. Optionally, portions of insurance related database 160 may be associated with memory modules that are separate from one another, such as a memory 120 of a client device 105.

### Exemplary Client Device for Automatically Generating Personal Articles Insurance Data

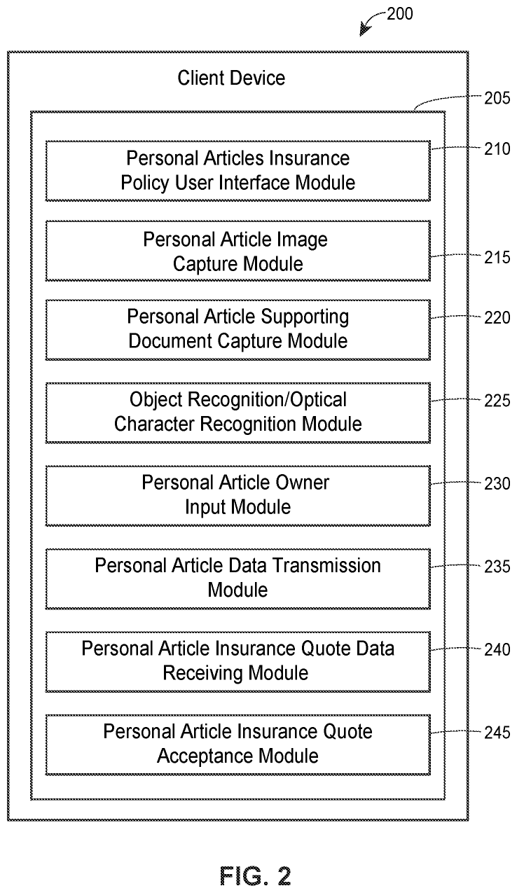

Turning to FIG. 2, a client or mobile device 200 may include a personal articles insurance policy user interface module 210, a personal articles image capture module 215, a personal articles supporting document capture module 220, an object recognition/optical character recognition module 225, a personal articles owner input module 230, a personal articles data transmission module 235, a personal articles insurance quote data receiving module 240, and a personal articles insurance quote acceptance module 245 stored on, for example, a memory 205. The client or mobile device 200 may be similar to the client or mobile device 105 of FIG. 1, and/or may include additional, less, or alternate functionality as that discussed elsewhere herein.

### Exemplary Remote Computing Device for Automatically Generating Personal Articles Insurance Data

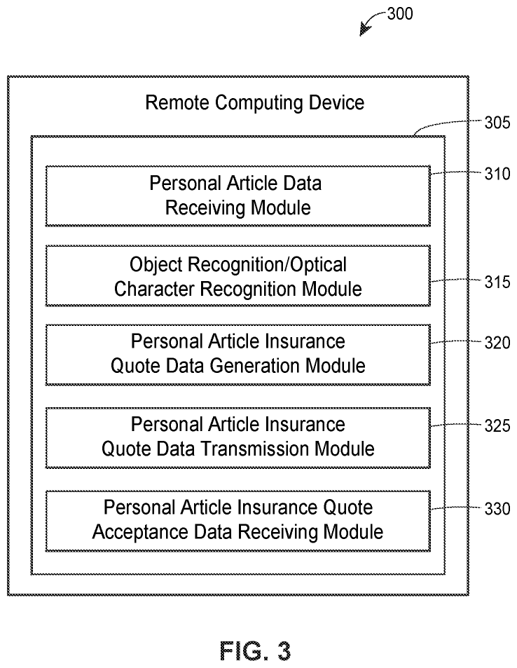

With reference to FIG. 3, a remote computing device 300 may include a personal articles data receiving module 310, an object recognition/optical character recognition module 315, a personal articles insurance quote data generation module 320, a personal articles insurance quote data transmission module 325, and a personal articles insurance quote acceptance data receiving module 330 stored on, for example, a memory 305. The remote computing device 300 may be similar to, for example, the remote computing device 110 of FIG. 1, and/or may include addition, less, or alternate functionality as that discussed elsewhere herein.

### Exemplary Method for Automatically Generating Personal Articles Insurance Data

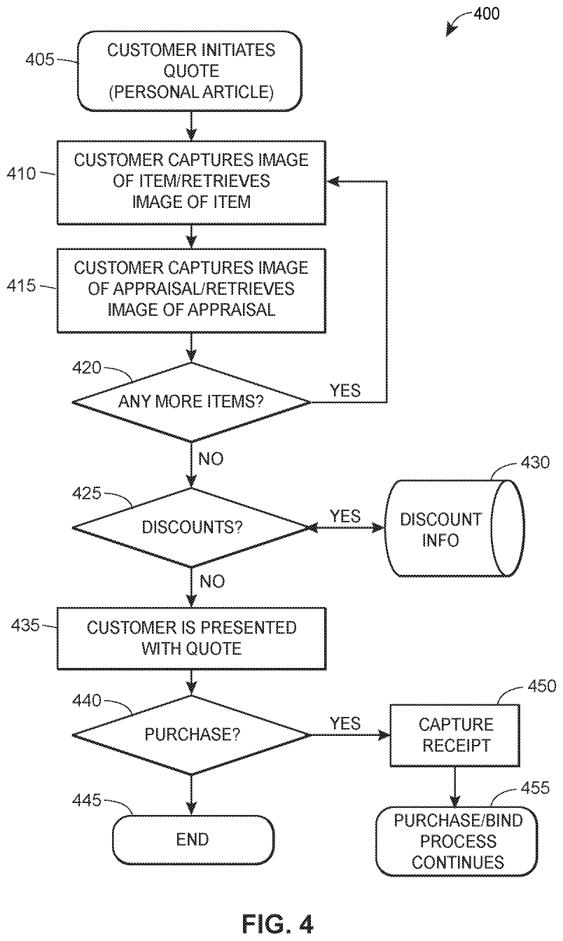

Turning to FIG. 4, a method of automatically generating personal articles insurance data (and/or personal articles insurance policies, quotes, pricing, discounts, etc.) 400 may be implemented by a first processor (e.g., processor 125 of client device 105 of FIG. 1) executing, for example, modules 210-245 of FIG. 2, and/or a second processor (e.g., processor 150 of remote computing device 110 of FIG. 1) executing, for example, modules 310-330 of FIG. 3. In particular, processor 125 may execute a personal articles insurance policy user interface module 210 to initiate a request for a personal articles insurance quote (block 405). The processor 125 may execute the personal articles image capture module 215 in response to, for example, a user of a client device 105 taking a photograph of a personal article using, for example, a digital camera 127 (block 410), such as a camera of a mobile device (e.g., smart phone). The processor 125 may execute a personal articles supporting document capture module 220 in response to, for example, a user of a client device 105 taking a picture of a supporting document (e.g., a purchase receipt, an appraisal, a certificate, etc.) associated with a personal article using, for example, a digital camera 127 (block 415), such as the camera of a mobile device, as indicated above.

The processor 125 may execute the object recognition/optical character recognition module 225 to extract personal articles information data from the digital image of the photograph and/or the digital image of the supporting documentation (blocks 410, 415). Alternatively, the processor 125 may execute the personal articles data transmission module 235 to transmit personal articles image data to a processor of a remote computing device (e.g., processor 150), and the processor 150 may execute the personal articles data receiving module 310 and the object recognition/optical character recognition module 315 to extract personal articles information data from the digital image of the photograph and/or the digital image of the supporting documentation (blocks 410, 415).

The processor 125 may further execute the personal articles insurance policy user interface module 210 to determine whether a user wishes to obtain an insurance quote for another personal article based upon, for example, a user input indicating whether the user wishes to obtain an insurance quote for another personal article (block 420). If the processor 125 determines that the user wishes to obtain an insurance quote for another personal article (block 420), the processor 125 may implement blocks 410, 420, 430. If the processor 125 determines that the user does not wish to obtain an insurance quote for another personal article (block 420), the processor 125 may determine whether any insurance discounts are available for a personal article (block 425).

If the processor 125 determines that a discount is available (block 425), the processor 125 may generate discount information data (block 430). If the processor 125 determines that no discounts are available (block 425), the processor 125 may execute a personal articles insurance quote generation module 320 to generate a personal articles insurance quote based, for example, upon at least one digital image of a photograph of the personal articles and/or at least one digital image of supporting documentation associated with the personal article(s), and may present the personal articles insurance quote to the user (block 435).

Additionally or alternatively, in circumstances when the processor 125 transmits personal articles image data and/or personal articles information data to a processor 150 of a remote computing device, the processor 150 may execute the personal articles insurance quote generation module 320 to generate a personal articles insurance quote (or pricing) based, for example, on at least one digital image of a photograph of the personal articles and/or at least one digital image of supporting documentation associated with the personal article, and may transmit personal articles insurance quote data to the user (block 435). In the event that the processor 150 generates the personal articles insurance quote data (block 435), the processor may execute the personal articles insurance quote data transmission module 325 to transmit personal articles insurance data to, for example, the processor 125.

The processor 125 may execute the personal articles insurance quote data receiving module 240 to receive the personal articles insurance quote data from the processor 150. The processor 125 may execute the personal articles insurance quote acceptance module 245 to determine whether the user wishes to accept the personal articles insurance quote (block 440). If the processor 125 determines that the user does not wish to accept the personal articles insurance quote (block 440), the processor 125 may end the personal articles insurance processes (block 445). If the processor 125 determines that the user wishes to accept the personal articles insurance quote (block 440), the processor 125 may further execute the personal articles image capture module 215 to capture an image of a purchase receipt (block 450). The processor 125 may execute the personal articles insurance quote acceptance module 245 to finalize the personal articles insurance policy purchase and bind the user to the associated terms.

The processor 125 may execute the personal articles owner input module 230 in response to, for example, a user entering information (e.g., answers to questions) regarding a personal article, and the processor 125 may generate personal articles owner input data based upon the user entered information. The processor 125 may further execute the personal articles data transmission module 235 to transmit the personal articles owner input data to, for example, a processor 150 of a remote computing device.

The processor 150 may further execute the personal articles insurance quote data generation module 320 to generate personal articles insurance quote data further based upon the personal articles owner input data. For example, the processor 150 may execute the personal articles insurance quote data generation module 320 to generate personal articles insurance quote data based upon the personal article owner input data, personal articles information data and/or digital image data.

### Exemplary Method for Automatically Generating Personal Articles Insurance Data

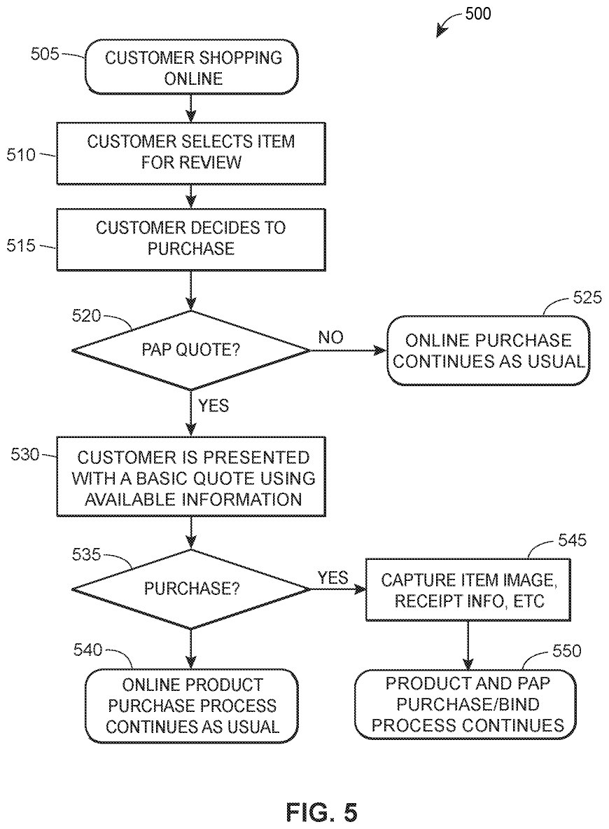

With reference to FIG. 5, a method of automatically generating personal articles insurance data (and/or personal articles insurance policies, quotes, pricing, discounts, etc.) 500 may be implemented by a first processor (e.g., processor 125 of client device 105 of FIG. 1) executing, for example, modules 210-245 of FIG. 2, and/or a second processor (e.g., processor 150 of remote computing device 110 of FIG. 1) executing, for example, modules 310-330 of FIG. 3.

In particular, processor 125 may execute a personal articles insurance policy user interface module 210 to initiate a request for a personal articles insurance quote in response to a user shopping online (block 505). The processor 125 may further execute the personal articles insurance policy user interface module 210 in response to a user selecting a personal article (block 510), such as a personal article that may be covered by a personal articles insurance policy or for which personal articles insurance is available for purchase. The processor 125 may further execute the personal articles insurance policy user interface module 210 when the user decides to purchase the personal article (block 515).

The processor 125 may further execute the personal articles insurance policy user interface module 210 and may determine whether the user desires a personal articles insurance quote in response to, for example, the user entering information indicative of whether the user desires a personal articles insurance quote (block 520). If the processor 125 determines that the user does not desire a personal articles insurance quote (block 520), the processor 125 may end the personal articles insurance data generation process (block 525), and the purchase may continue. If the processor 125 determines that the user desires a personal articles insurance quote (block 520), the processor 125 may execute a personal articles insurance quote generation module 320 to generate a personal articles insurance quote based, for example, upon at least one digital image of a photograph of the personal article and/or at least one digital image of supporting documentation associated with the personal article, and may present the personal articles insurance quote to the user (block 520).

Additionally or alternatively, in circumstances when the processor 125 transmits personal article image data and/or personal article information data to a processor 150 of a remote computing device, the processor 150 may execute the personal articles insurance quote generation module 320 to generate a personal articles insurance quote based, for example, on at least one digital image of a photograph of the personal article and/or at least one digital image of supporting documentation associated with the personal article, and may transmit personal articles insurance quote data to the user (block 530).

In the event that the processor 150 generates the personal articles insurance quote data (block 520), the processor may execute the personal articles insurance quote data transmission module 325 to transmit personal articles insurance data to, for example, the processor 125. The processor 125 may execute the personal articles insurance quote data receiving module 240 to receive the personal articles insurance quote data from the processor 150. The processor 125 may execute the personal articles insurance quote acceptance module 245 to determine whether the user wishes to purchase a personal articles insurance policy (block 535). If the processor 125 determines that the user does not wish to purchase a personal articles insurance policy (block 535), the processor 125 may end the personal article insurance data generation process (block 540). If the processor 125 determines that the user wishes to purchase a personal articles insurance policy (block 535), the processor 125 may execute the personal articles image capture module 215 in response to, for example, a user of a client device 105 taking a photograph of a personal article using, for example, a digital camera 127 (block 545).

The processor 125 may execute a personal articles supporting document capture module 220 in response to, for example, a user of a client or mobile device 105 taking a picture of a supporting document (e.g., a purchase receipt, an appraisal, a certificate, etc.) associated with a personal article using, for example, a digital camera 127 (block 545). The processor 125 may execute the object recognition/optical character recognition module 225 to extract personal article information data from the digital image of the photograph and/or the digital image of the supporting documentation (block 545).

Additionally or alternatively, the processor 125 may execute the personal articles data transmission module 235 to transmit personal articles image data to a processor of a remote computing device (e.g., processor 150), and the processor 150 may execute the personal articles data receiving module 310 and the object recognition/optical character recognition module 315 to extract personal articles information data from the digital image of the photograph and/or the digital image of the supporting documentation (block 545). The processor 125 may execute the personal articles insurance quote acceptance module 245 to finalize the personal articles insurance policy purchase and bind the user to the associated terms (block 550).

Alternatively, a person shopping online may purchase personal article policy (PAP) coverage without sending any additional documentation. For example, a potential arrangement between a product vendor and an associated insurance company may include permission from a customer through making an election to buy the PAP. The vendor may send documentation of the purchase and/or the associated personal article directly to the insurance company. An associated transaction may include safeguards to protect against fraud.

### Exemplary Method for Automatically Generating Personal Articles Insurance Data

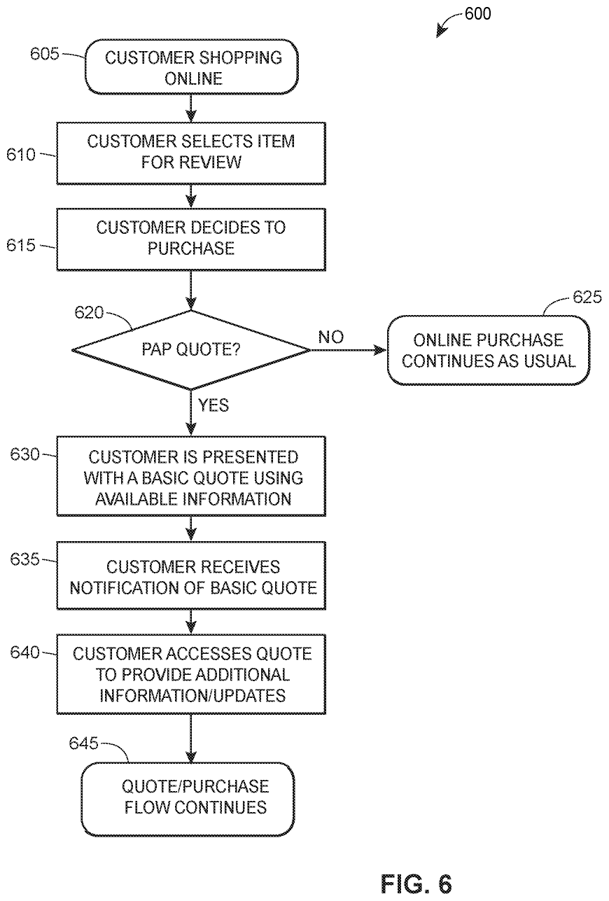

Turning to FIG. 6, a method of automatically generating personal article insurance data (and/or personal articles insurance policies, quotes, pricing, discounts, etc.) 600 may be implemented by a first processor (e.g., processor 125 of client device 105 of FIG. 1) executing, for example, modules 210-245 of FIG. 2, and/or a second processor (e.g., processor 150 of remote computing device 110 of FIG. 1) executing, for example, modules 310-330 of FIG. 3. In particular, processor 125 may execute a personal articles insurance policy user interface module 210 to initiate a request for a personal article(s) insurance quote in response to a user shopping online (block 605). The processor 125 may further execute the personal articles insurance policy user interface module 210 in response to a user selecting a personal article (block 610).

The processor 125 may further execute the personal articles insurance policy user interface module 210 when the user decides to purchase the personal article (block 615). The processor 125 may further execute the personal articles insurance policy user interface module 210 and may determine whether the user desires a personal articles insurance quote in response to, for example, the user entering information indicative of whether the user desires a personal articles insurance quote (block 620).

If the processor 125 determines that the user does not desire a personal articles insurance quote (block 620), the processor 125 may end the personal articles insurance data generation process (block 625), and the purchase may continue. If the processor 125 determines that the user desires a personal articles insurance quote (block 620), the processor 125 may execute a personal articles insurance quote generation module 320 to generate a personal articles insurance quote based, for example, upon at least one digital image of a photograph of the personal article(s) and/or at least one digital image of supporting documentation associated with the personal article(s), and may present the personal articles insurance quote to the user (block 630).

Additionally or alternatively, in circumstances when the processor 125 transmits personal article(s) image data and/or personal article(s) information data to a processor 150 of a remote computing device, the processor 150 may execute the personal articles insurance quote generation module 320 to generate a personal article(s) insurance quote based, for example, on at least one digital image of a photograph of the personal article(s) and/or at least one digital image of supporting documentation associated with the personal article(s), and/or may transmit personal articles insurance quote data to the user (block 630). In the event that the processor 150 generates the personal articles insurance quote data (block 6300), the processor may execute the personal articles insurance quote data transmission module 325 to transmit personal articles insurance data to, for example, the processor 125.

The processor 125 may execute the personal articles insurance quote data receiving module 240 to receive the personal articles insurance quote data from the processor 150. The processor 125 may execute the personal articles insurance quote data receiving module 240 to receive a notification of a basic personal articles insurance quote (block 635). The processor 125 may execute the personal articles owner input module 230 to provide additional information and/or updates regarding the personal article(s) (block 640). The processor 125 may execute the personal articles insurance quote acceptance module 245 to finalize the personal articles insurance policy purchase and bind the user to the associated terms (block 645).

Alternatively, a person shopping online may purchase personal article policy (PAP) coverage without sending any additional documentation. For example, a potential arrangement between a product vendor and an associated insurance company may include permission from a customer through making an election to buy the PAP. The vendor may send documentation of the purchase and/or the associated personal article directly to the insurance company. An associated transaction may include safeguards to protect against fraud.

### Exemplary Method for Automatically Generating Personal Articles Insurance Data

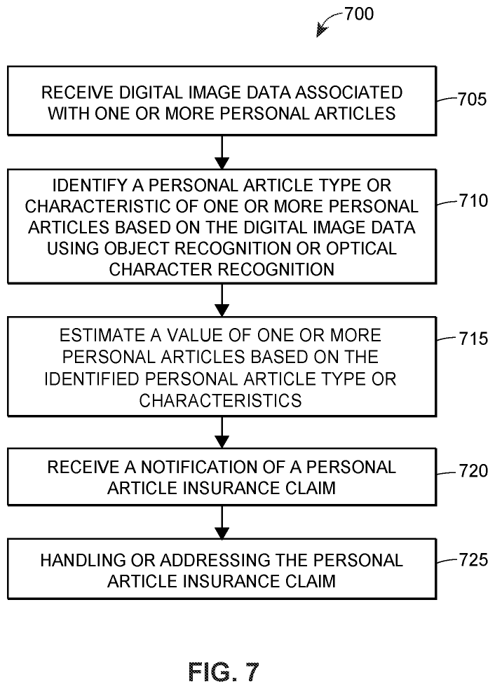

With reference to FIG. 7, a method of automatically generating personal article insurance data (and/or personal articles insurance policies, quotes, pricing, discounts, etc.) 700 may be implemented by a first processor (e.g., processor 125 of client device 105 of FIG. 1) executing, for example, modules 210-245 of FIG. 2, and/or a second processor (e.g., processor 150 of remote computing device 110 of FIG. 1) executing, for example, modules 310-330 of FIG. 3. In particular, processor 125 may execute a personal article data receiving module 310 to cause the processor 125 to receive digital image data associated with one or more personal articles (block 705). Processor 125 may execute an object recognition/optical character recognition module 315 to cause the processor 125 to identify a personal article type or characteristic of one or more personal articles based upon the digital image data using object recognition of optical character recognition (block 710).

Processor 125 may execute a personal article insurance quote data generation module 315 to cause the processor 125 to estimate a value of one or more personal articles based upon the identified personal article type or characteristics (block 715). For instance, the processor 125 may compare the personal article type or characteristic of one or more personal articles identified with a database of products and associated prices, or retrieve estimated prices or values of products similar to those identified (and/or products having features similar to those identified) from various websites or databases, such as online shopping websites.

Processor 125 may execute a personal articles insurance policy user interface module 210 to cause the processor 125 to receive a notification of a personal article insurance claim (block 720). For instance, an insurance customer may notify the insurance provider of an insurance claim, such as resulting from damage caused by a water or fire event in the home, via their mobile device or telephone. The notification may be routed to, or accessed by, the processor 125.

Processor 125 may execute a personal articles insurance policy user interface module 210 to cause the processor 125 to handle or address the personal article insurance claim (block 725). For instance, the processor 125 may pre-populate a proposed insurance claim for the customer to approve or submit; estimate a payout amount based upon the damages and/or estimated value of the personal article(s); pay the insurance claim, such as by transferring monies to the customer or a customer financial account; verify the accuracy of the insurance claim; and/or perform other actions to facilitate quickening the claim process and/or enhancing the customer experience. The method may include additional, less, or alternate actions, including those discussed elsewhere herein.

### Exemplary Method for Automatically Generating Personal Articles Insurance Data

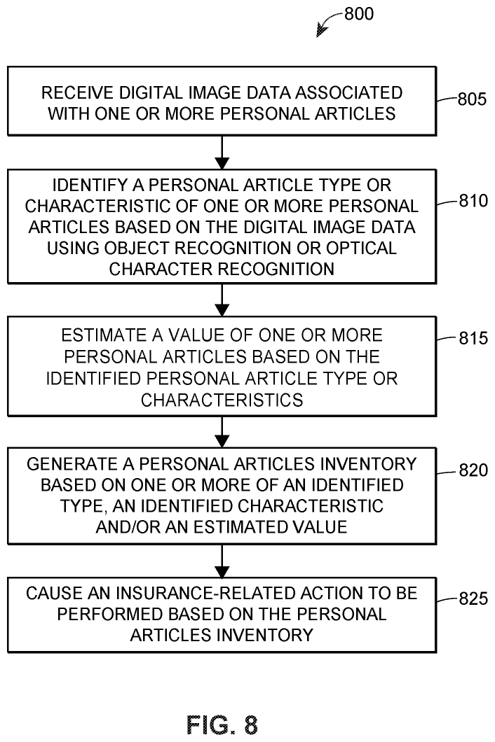

Turning to FIG. 8, a method of automatically generating personal article insurance data (and/or personal articles insurance policies, quotes, pricing, discounts, etc.) 600 may be implemented by a first processor (e.g., processor 125 of client device 105 of FIG. 1) executing, for example, modules 210-245 of FIG. 2, and/or a second processor (e.g., processor 150 of remote computing device 110 of FIG. 1) executing, for example, modules 310-330 of FIG. 3. In particular, processor 125 may execute a personal article data receiving module 310 to cause the processor 125 to receive digital image data associated with one or more personal articles (block 805). Processor 125 may execute an object recognition/optical character recognition module 315 to cause the processor 125 to identify a personal article type or characteristic of one or more personal articles based upon the digital image data using object recognition or optical character recognition (block 810).

Processor 125 may execute a personal article insurance quote data generation module 315 to cause the processor 125 to estimate a value of one or more personal articles based upon the identified personal article type or characteristics (block 815). For instance, the processor 125 may compare the personal article type or characteristic of one or more personal articles identified with a database of products and associated prices, or retrieve estimated prices or values of products similar to those identified (and/or products having features similar to those identified) from various websites or databases, such as online shopping websites.

Processor 125 may execute a personal articles insurance policy user interface module 210 to cause the processor 125 to generate a personal articles inventory based upon one or more of an identified type, an identified characteristic and/or an estimated value (block 820). The inventory may be associated with a specific insured or family, and may include the type and features of various belongings, their estimated value, and/or their purchase or replacement cost.

Processor 125 may execute a personal articles insurance policy user interface module 210 to cause the processor 125 to initiate an insurance-related action to be performed based upon the personal articles inventory (block 825). For instance, the processor 125 may generate or adjust a personal articles insurance quote, premium, discount, or policy based upon the inventory or an updated inventory. Processor 125 may send the personal articles insurance quote, premium, discount, or policy generated or updated to the customer for their review, approval, or modification, such as via wireless communication or data transmission with the insured's mobile device.

Additionally or alternatively, upon notification of an insurance claim, the processor 125 may use the inventory list created to pre-populate a proposed insurance claim for the customer to approve or submit; estimate a payout amount based upon the damages and/or estimated value of the personal article(s); pay the insurance claim, such as by transferring monies to the customer or a customer financial account; verify the accuracy of the insurance claim; and/or perform other actions to facilitate quickening the claim process and/or enhancing the customer experience. The method may include additional, less, or alternate actions, including those discussed elsewhere herein.

### Exemplary Computer-Implemented Method

In one aspect, a computer implemented method for automatically generating personal articles insurance data and/or personal articles insurance policies, quotes, pricing, discounts, etc. may be provided. The method may include (1) receiving, at a processor of a computing device, digital image data from an electronic device, in response to the processor executing a digital image data receiving module, wherein the digital image data is representative of documentation for at least one personal article. The method may include (2) generating, by a processor of a computing device, personal article(s) information data, based upon the digital image data, in response to the processor executing a personal articles information data recognition module, wherein the personal article(s) information data is representative of identifying characteristics of the at least one personal article. The method may further include (3) generating, by a processor of a computing device, personal article(s) insurance data and/or personal article(s) insurance policies, quotes, pricing, and/or discounts, based upon the personal article(s) information data, in response to the processor executing a personal articles insurance data generation module. The method may yet further include (4) utilizing digital image data that is representative of an image of alpha-numeric text related to the at least one personal article. The method may also include (5) utilizing or employing a personal articles information data recognition module that is an optical character recognition module that extracts personal article information data from the image of the alpha-numeric text; (6) utilizing or employing a digital image data that is representative of a photograph of the at least one personal article; and/or (7) utilizing or employing a personal articles information data recognition module that is an object recognition module that extracts personal article information data from the photograph of the at least one personal article.

The method may also include (8) receiving, at a processor of a computing device, insurance customer answer data, wherein the insurance customer answer data is representative of answers, provided by an insurance customer. Exemplary questions may include or be representative of at least one of: whether the personal article is kept in a safe, whether the personal article is kept in a vault, how long the personal article is kept in a safe, how long the personal article is kept in a vault, whether the personal article is gem-printed, whether the personal article is GIA certified, whether the personal article is EGL certified, whether insurance coverage for the personal article is desired when the personal article is unattended, whether the insurance customer has an alarm certificate, whether the personal article is for professional use, and/or whether the personal article is for non-professional use. Additional or alternate questions may be asked, or the questions may be optional. The personal article insurance data may be further based upon the insurance customer answer data. The method may include additional, fewer, or alternate actions, including those discussed elsewhere herein.

### Exemplary Computer System

In one aspect, a computer system for automatically generating personal articles insurance data and/or personal articles insurance policies, quotes, pricing, and/or discounts may be provided. The computer system may include a digital image data receiving module stored on a memory that, when executed by a processor of a computing device, causes the processor to receive digital image data from an electronic device, wherein the digital image data is representative of documentation for at least one personal article. The system may also include a personal articles information recognition module stored on a memory that, when executed by a processor of a computing device, causes the processor to generate personal articles information data based upon the digital image data, wherein the personal articles information data is representative of identifying characteristics of the at least one personal article. The system may further include a personal articles insurance data generation module stored on a memory that, when executed by a processor of a computing device, causes the processor to generate personal articles insurance data and/or personal articles insurance policies, quotes, pricing, and/or discounts based upon the personal articles information data. The system may yet further include digital image data that may be representative of at least one photograph of the at least one personal article and at least one of: an appraisal of the at least one personal article, a purchase receipt for the at least one personal article, a certification associated with the at least one personal article, and/or a written description of the at least one personal article.

The system may also include personal article information data that may be further used for at least one of: cross validating an appraisal of the personal article, determining whether multiple documents match the personal article, determining whether multiple images of the personal article match, validating attributes of the personal article for fraud, determine whether the digital image data is representative of an internet photo, determine whether a date associated with digital image data associated with a picture of the at least one personal article is dated prior to a purchase receipt for the at least one personal article, determine whether a same photo of the at least one personal article was previously submitted, determining whether a geo-tagged location differs from an insurance customer location during purchase of a personal article, and determine potential insurance discounts, and/or identify prior insurance claims related to the personal article(s).

The system may further include an insurance customer answer data receiving module stored on a memory that, when executed by a processor of a computing device, causes the processor to receive insurance customer answer data, wherein the insurance customer answer data is representative of answers, provided by an insurance customer. Exemplary questions may include or be representative of at least one of: whether the personal article is kept in a safe, whether the personal article is kept in a vault, how long the personal article is kept in a safe, how long the personal article is kept in a vault, whether the personal article is gem-printed, whether the personal article is GIA certified, whether the personal article is EGL certified, whether insurance coverage for the personal article is desired when the personal article is unattended, whether the insurance customer has an alarm certificate, whether the personal article is for professional use, and/or whether the personal article is for non-professional use. Additional or alternate questions may, or may not, be used. The personal article insurance data may be further based upon the insurance customer answer data.

The system may yet further include a personal articles information validation module stored on a memory that, when executed by a processor of a computing device, causes the processor to validate the insurance customer answer data based upon the personal articles information data. The computer system may include additional, less, or alternate functionality, including that discussed elsewhere herein.

### Exemplary Computer-Readable Medium

A non-transitory computer-readable medium storing instructions that, when executed by a processor of a computing device, cause the processor to automatically generate personal articles insurance data and/or personal articles insurance policies, quotes, pricing, discounts, etc. may be provided. The instructions may include a digital image data receiving module that, when executed by a processor of a computing device, causes the processor to receive digital image data from an electronic device, wherein the digital image data is representative of documentation for at least one personal article. The non-transitory computer-readable medium may also include a personal articles information recognition module that, when executed by a processor of a computing device, causes the processor to generate personal articles information data and/or personal articles insurance policies, quotes, pricing, discounts, etc. based upon the digital image data, wherein the personal articles information data is representative of identifying characteristics of the at least one personal article. The non-transitory computer-readable medium may further include a personal articles insurance data generation module that, when executed by a processor of a computing device, causes the processor to generate personal articles insurance data and/or personal articles insurance policies, quotes, pricing, discounts, etc. based upon the personal article information data.

The non-transitory computer-readable medium may yet further include a digital image data transmission module that, when executed by a processor of a client device, causes the processor to transmit digital image data from the processor of the client device to a processor of a remote computing device. The non-transitory computer-readable medium may also include a personal articles information recognition module and/or a personal articles insurance data generation module that may be executed by a processor of a remote computing device, and may also include a personal articles insurance data transmission module that, when executed by the processor of the remote computing device, causes the processor of the remote computing device to transmit personal articles insurance data and/or personal articles insurance policies, quotes, pricing, discounts, etc. to the processor of the client device.

The non-transitory computer-readable medium may further include a personal articles information data transmission module that, when executed by a processor of a client device, causes the processor of the client device to transmit personal articles information data and/or personal articles insurance policies, quotes, pricing, discounts, etc. from the processor of the client device to a processor of a remote computing device. The non-transitory computer-readable medium may yet further include a personal articles insurance data generation module that is executed by a processor of a remote computing device, and may also include a personal articles insurance data transmission module that, when executed by the processor of the remote computing device, causes the processor of the remote computing device to transmit personal articles insurance data and/or personal articles insurance policies, quotes, pricing, discounts, etc. to the processor of the client device.

The non-transitory computer-readable medium may also include a personal articles insurance quote generation module that, when executed by a processor of a computing device, causes the processor to generate personal articles insurance quote data and/or personal articles insurance policies, quotes, premiums, pricing, discounts, etc. based upon the personal articles insurance data. The non-transitory computer-readable medium may further include a personal articles insurance quote acceptance module that, when executed by a processor of a computing device, causes the processor to generate personal articles insurance quote acceptance data in response to a user accepting a quote for personal article insurance.

The non-transitory computer-readable medium may further include digital image data that may be representative of an image of alpha-numeric text related to the at least one personal article, and the personal articles information data recognition module may be an optical character recognition module that extracts personal article information from the image of the alpha-numeric text. The non-transitory computer-readable medium may yet further include digital image data that may be representative of a photograph of the at least one personal article, and the personal articles information data recognition module may be an object recognition module that extracts personal article information from the photograph of the at least one personal article.

### Exemplary Personal Articles Insurance Quote Generation

In one aspect, a computer-implemented method for automatically generating personal articles insurance policy quotes, pricing, discounts, and/or policies may be provided. The method may include (1) receiving, at a processor of a computing device, digital image data from an electronic device, in response to the processor executing a digital image data receiving module, wherein the digital image data is representative of documentation for at least one personal article; (2) generating, using a processor of a computing device, personal articles information data and/or personal articles insurance policy quotes, pricing, discounts, and/or policies, based upon the digital image data, in response to the processor executing a personal articles information data recognition module, wherein the personal articles information data is representative of identifying characteristics of the at least one personal article; (3) generating, using a processor of a computing device, personal articles insurances data and/or personal articles insurance policy quotes, pricing, discounts, and/or policies, based upon the personal articles information data, in response to the processor executing a personal articles insurance data generation module; and/or (4) causing, using a processor of the computing, personal articles insurances data and/or personal articles insurance policy quotes, pricing, discounts, and/or policies to be displayed to facilitate providing personal articles insurance policy quotes, pricing, discounts, and/or policies to insurance customers and/or purchase of personal articles insurance policies. The method may include additional, fewer, or alternate actions, including those discussed elsewhere herein.

For instance, the digital image data may be representative of an image of alpha-numeric text related to the at least one personal article. The personal articles information data recognition module may be an optical character recognition module that extracts personal article information data from the image of the alpha-numeric text. The digital image data may be representative of a photograph of the at least one personal article. The personal articles information data recognition module may be an object recognition module that extracts personal articles information data from the photograph of the at least one personal article.

The method may further include receiving, at a processor of a computing device, insurance customer answer data, wherein the insurance customer answer data is representative of answers, provided by an insurance customer. Exemplary questions may include or be representative of at least one of: whether the personal article is kept in a safe, whether the personal article is kept in a vault, how long the personal article is kept in a safe, how long the personal article is kept in a vault, whether the personal article is gem-printed, whether the personal article is GIA certified, whether the personal article is EGL certified, whether insurance coverage for the personal article is desired when the personal article is unattended, whether the insurance customer has an alarm certificate, whether the personal article is for professional use, and/or whether the personal article is for non-professional use. Other questions may be used. The personal articles insurance data may further be based upon the insurance customer answer data.

### Exemplary Personal Articles Insurance Quoting

In one aspect, a computer-implemented method for automatically handling personal articles insurance policy quotes, pricing, discounts, and/or policies may be provided. The method may include (1) receiving, via a processor (or remote server), a data transmission or wireless communication including digital image data of, and/or associated with, one or more personal articles of a customer, the digital image data of, and/or associated with, one or more personal articles being generated by a mobile device or computing device of the customer and transmitted to the processor; (2) identifying, via the processor, a type and/or characteristic of each of the one or more personal articles by employing object recognition (OR) and/or optical character recognition (OCR) techniques on the digital image data of, and/or associated with, the one or more personal articles; (3) estimating, via the processor, a value for each of the one or more personal articles based upon the type and/or characteristic of each respective personal article that is determined from the OR and/or OCR techniques employed on the digital image data of, and/or associated with, the personal articles; (4) generating, via the processor, a personal articles insurance quote, pricing, discount, and/or policy for the customer based upon the estimated value of the personal articles; and/or (5) causing, via the processor, the personal articles insurance quote, pricing, discount, and/or policy to be presented or displayed on the mobile device or computing device of the customer (such as via wireless communication or data transmission of personal articles insurance-related information from the processor to the mobile device or computing device of the customer) for review, approval, and/or modification by the customer to facilitate more accurate pricing and/or pricing that is a more accurate reflection of risk for personal articles insurance policies. The method may include additional, less, or alternate actions, including those discussed elsewhere herein.

For instance, the method may include building and/or updating, via the processor, an inventory or list of personal belongings of the customer from the digital image data of personal articles; and/or generating or providing, via the processor, personal articles insurance recommendations to the customer based upon the inventory or list of personal belongings, such as recommendations to increase or decrease personal articles insurance coverages, deductibles, and/or liabilities.

Additionally or alternatively, the method may include building, adjusting, and/or updating, via the processor, an inventory or list of personal belongings of the customer from the digital image data of personal articles; and/or using, via the processor, the inventory or list of personal belongings, and/or estimations of value for each of the personal belongings in the inventory or list that are generated using OR and/or OCR techniques performed on the digital image data of personal articles, to handle or address insurance claims (e.g., estimate replacement costs for damaged personal articles) resulting from insurance-related events, such as in the cause of house fire that results in a partial or total loss of the personal belongings.

The digital image data may be representative of at least one photograph of the at least one personal article and at least one of: an appraisal of the at least one personal article, a purchase receipt for the at least one personal article, a certification associated with the at least one personal article, and/or a written description of the at least one personal article.

The method may further include analysis, by the processor, of the digital image data of, and/or associated with, the personal articles to (1) cross validate an appraisal of a personal article; (2) determine whether multiple documents match the personal article; (3) determine whether multiple images of the personal article match; (4) validate attributes of the personal article for fraud; (5) determine whether the digital image data is representative of an internet photo; (6) determine whether a date associated with digital image data associated with a picture of the at least one personal article is dated prior to a purchase receipt for the at least one personal article; (7) determine whether a same photo of the at least one personal article was previously submitted; (8) determine whether a geo-tagged location differs from an insurance customer location during purchase of a personal article; and/or (9) determine potential insurance discounts; and/or (10) identify prior insurance claims related to the personal article.

The method may further include receiving, at the processor, insurance customer answer data, wherein the insurance customer answer data is representative of answers, provided by an insurance customer. Exemplary questions may include or be representative of at least one of: whether a personal article is kept in a safe, whether the personal article is kept in a vault, how long the personal article is kept in a safe, how long the personal article is kept in a vault, whether the personal article is gem-printed, whether the personal article is GIA certified, whether the personal article is EGL certified, whether insurance coverage for the personal article is desired when the personal article is unattended, whether the insurance customer has an alarm certificate, whether the personal article is for professional use, and/or whether the personal article is for non-professional use. Additional, less, or alternate questions may be used.

### Exemplary Personal Articles Insurance Claim Handling

In one aspect, a computer-implemented method for handling personal articles insurance claims may be provided. The method may include (1) receiving, via a processor (or remote server), a data transmission or wireless communication including digital image data of, and/or associated with, one or more personal articles of a customer, the digital image data of, and/or associated with, one or more personal articles being generated by a mobile device or computing device of the customer and transmitted to the processor; (2) identifying, via the processor, a type and/or characteristic of each of the one or more personal articles by employing object recognition (OR) and/or optical character recognition (OCR) techniques on the digital image data of, and/or associated with, the one or more personal articles; (3) estimating, via the processor, a value for each of the one or more personal articles based upon the type and/or characteristic of each respective personal article that is determined from the OR and/or OCR techniques employed on the digital image data; (4) receiving, via the processor, a data transmission or wireless communication, such from the mobile device or computing device of the customer, and/or other notification from the customer of a personal articles insurance policy claim (associated with a personal articles insurance policy covering the personal articles) and/or an insurance-related event (e.g., hurricane, flood, fire, tornado, etc.) that has led to a partial or total loss of one or more personal articles covered by a personal articles insurance policy; and/or (5) handling or addressing, via the processor, the personal articles insurance claim (such as by estimating replacement cost or values) utilizing the estimated values of damaged or lost personal articles that have been estimated from the OR and/or OCR techniques employed on the digital image data of, and/or associated with, the one or more personal articles to facilitate more efficient and/or more accurate personal articles insurance claim handling. The method may include additional, fewer, or alternate actions, including those discussed elsewhere herein.

For instance, the digital image data may be representative of at least one photograph of the at least one personal article and at least one of: an appraisal of the at least one personal article, a purchase receipt for the at least one personal article, a certification associated with the at least one personal article, or a written description of the at least one personal article. The method may further include analysis, by the processor, of the digital image data of, and/or associated with, the personal articles (such as during the estimation of the value of each personal article) to (1) cross validate an appraisal of a personal article; (2) determine whether multiple documents match the personal article; (3) determine whether multiple images of the personal article match; (4) validate attributes of the personal article for fraud; (5) determine whether the digital image data is representative of an internet photo; (6) determine whether a date associated with digital image data associated with a picture of the at least one personal article is dated prior to a purchase receipt for the at least one personal article; (7) determine whether a same photo of the at least one personal article was previously submitted; (8) determine whether a geo-tagged location differs from an insurance customer location during purchase of a personal article; (9) determine potential insurance discounts; and/or (10) identify prior insurance claims related to the personal article.

The method may include receiving, at the processor, insurance customer answer data, wherein the insurance customer answer data may be representative of answers, provided by an insurance customer. Exemplary questions may include or be representative of at least one of: whether a personal article is kept in a safe, whether the personal article is kept in a vault, how long the personal article is kept in a safe, how long the personal article is kept in a vault, whether the personal article is gem-printed, whether the personal article is GIA certified, whether the personal article is EGL certified, whether insurance coverage for the personal article is desired when the personal article is unattended, whether the insurance customer has an alarm certificate, whether the personal article is for professional use, and/or whether the personal article is for non-professional use.

### Exemplary Personal Articles Inventory Generation

In one aspect, a computer-implemented method for automatically inventorying personal articles for insurance-related purposes may be provided. The method may include (1) receiving, via a processor (or remote server), a data transmission or wireless communication including digital image data of, and/or associated with, one or more personal articles of a customer, the digital image data of, and/or associated with, the one or more personal articles being generated by a mobile device or computing device of the customer and transmitted to the processor; (2) identifying, via the processor, a type and/or characteristic of each personal article by employing object recognition (OR) and/or optical character recognition (OCR) techniques on the digital image data of, and/or associated with, the one or more personal articles; (3) estimating, via the processor, a value for each of the one or more personal articles based upon the type and/or characteristic of each respective personal article that is determined from the OR and/or OCR techniques employed on the digital image data of, and/or associated with, each of the one or more personal articles; (4) generating, updating, or adjusting, via the processor, a personal articles inventory of personal belongings for the customer based upon, and/or that includes, (i) the type and/or characteristic of each personal article; and/or (ii) the estimated value of the one or more personal articles that is estimated from the OR and/or OCR techniques employed on the digital image data; and/or (5) causing, via the processor, an insurance-related action to be performed based upon the personal articles inventory to facilitate more accurate insurance quoting, pricing, and/or claim handling. The method may include additional, fewer, or alternate actions, including those discussed elsewhere herein.

For instance, the insurance-related action may be handling, addressing, and/or estimating, via the processor, a personal articles insurance claim associated with one or more of the personal articles being damaged or lost based upon the personal articles inventory of personal belongings for the customer generated using OR and/or OCR techniques; and/or (i) the type and/or characteristic of each personal article; and/or (ii) the estimated value of the one or more personal articles that is estimated from the OR and/or OCR techniques employed on the digital image data.

Additionally or alternatively, the insurance-related action may be generating a personal articles insurance quote, via the processor, based upon the personal articles inventory of personal belongings for the customer generated using OR and/or OCR techniques; and/or (i) the type and/or characteristic of each personal article; and/or (ii) the estimated value of the one or more personal articles that is estimated from the OR and/or OCR techniques employed on the digital image data.

### Exemplary Method of Insurance Quote Generation

Preferably, the present embodiments may be related to, or focus on, quoting, billing, and/or customer service. Additionally or alternatively, the present embodiment may be related to selling insurance, updating insurance or insurance policies, and/or estimating or handling insurance claims.

Personal belongings may be identified from computer analysis of images or pictures, such as televisions, beds, desks, dressers, tables, sofas, chairs, coins, jewelry, electronics, appliances, etc. The items identified may be used to update an inventory or listing of personal articles.

The present embodiments may facilitate a more accurate determination of real value of items. For instance, recent receipts or appraisals may be used (such as being captured and submitted to an insurance provider for analysis via images taken by a mobile device). Also, images of items may be used to verify that the item or items is an actual item, and not just a fake item, such as an item (e.g., wedding ring or other jewelry) captured or copied from a website. The images may also be used to estimate the actual condition of the item(s). Accuracy of items may be determined, at least in part, from analysis or comparison of date of purchase (determined from a purchase receipt or bill) with date of image receipt or date that the image was taken, such as noted by a time stamp.

The determination that an item is real, of its current condition, and/or its current estimated or replacement value may be used to generate more accurate personal articles insurance quotes, update existing insurance policies and coverages to more accurately reflect the items being insured, handle insurance claims associated with damage to, or loss of, the insured items; estimate or generate more accurate insurance claims for insured approval; identify potential build up; and/or make things easier for the insurance customer, i.e., enhance the customer experience.

The present embodiments may also be used to verify that an amount of personal articles insurance that a customer presently has is actually appropriate, or alternatively, needs to be updated. Appropriate notifications may then be sent to the insured, such as that the amount of personal articles insurance that they currently have is appropriate or needs to be updated.

In one aspect, a computer-implemented method for automatically inventorying personal articles for insurance-related purposes may be provided. The method may include (1) receiving, via a processor (or remote server), a data transmission or wireless communication including digital image data of, and/or associated with, one or more personal articles of a customer, the digital image data of, and/or associated with, the one or more personal articles being generated by a mobile device or computing device of the customer and transmitted to the processor; (2) identifying or verifying, via the processor, a type and/or characteristic of each personal article by employing object recognition (OR) and/or optical character recognition (OCR) techniques on the digital image data of, and/or associated with, the one or more personal articles; (3) receiving, via the processor, another or the same data transmission or wireless communication including additional digital image data of, and/or associated with, an appraisal, receipt, or other acceptable documentation tending to establish or prove a current value or worth, or replacement cost, of a corresponding personal article, the additional digital image data of, and/or associated with, the appraisal, receipt, or other acceptable documentation being generated by a mobile device or computing device of the customer and transmitted to the processor; (4) generating, via the processor, a quote for a personal articles insurance policy that covers the one or more personal articles based upon the current value or worth of the one or more personal articles as established or evidenced by the additional digital image data of, and/or associated with the appraisal, receipt, or other acceptable documentation (and/or computer analysis thereof, such as via OR or OCR techniques); and/or (5) causing, via the processor, the quote for the personal articles insurance policy to be transmitted and displayed on a mobile device of the customer for their review, modification, or approval to facilitate providing more accurate or appropriate levels of personal articles insurance coverage to customers. The method may include additional, less, or alternate actions, including those discussed elsewhere herein, and may be implemented via one or more local or remote processors, or via computer-executable instructions stored on non-transitory computer-readable media or medium.

For instance, the method may include handling, addressing, and/or estimating, via the processor, a personal articles insurance claim associated with one or more of the personal articles being damaged or lost based upon the current value or worth of the one or more personal articles as established or evidenced by the additional digital image data of, and/or associated with the appraisal, receipt, or other acceptable documentation.

The method may include building or updating a personal articles inventory for an insured or family based upon the digital image data and/or additional digital image received. The method may include identifying potential building up based upon analysis of the digital image data and/or additional digital image received.

The method may include pre-populating an insurance application for an insured using, or based upon, the digital image data and/or additional digital image received. Additionally or alternatively, the method may include asking an insured or insurance customer one or more questions to help verify the value, current worth, current location, and/or current condition of the personal article(s) to be insured by the personal articles insurance policy, such as via their mobile device. The method may also include notifying, via their mobile device, an insured or insurance customer that an update to existing insurance policy is appropriate based upon analysis of the digital image data and/or additional digital image received.

### Exemplary Computer Systems

In one aspect, a computer system configured for automatically handling personal articles insurance policy quotes, pricing, discounts, and/or policies may be provided. The computer system may include one or more processors configured to: (1) receive a data transmission or wireless communication including digital image data of, and/or associated with, one or more personal articles of a customer, the digital image data of, and/or associated with, one or more personal articles being generated by a mobile device or computing device of the customer and transmitted to the processor; (2) identify a type and/or characteristic of each of the one or more personal articles by employing object recognition (OR) and/or optical character recognition (OCR) techniques on the digital image data of, and/or associated with, the one or more personal articles; (3) estimate a value for each of the one or more personal articles based upon the type and/or characteristic of each respective personal article that is determined from the OR and/or OCR techniques employed on the digital image data of, and/or associated with, the personal articles; (4) generate a personal articles insurance quote, pricing, discount, and/or policy for the customer based upon the estimated value of the personal articles; and/or (5) cause the personal articles insurance quote, pricing, discount, and/or policy to be presented or displayed on the mobile device or computing device of the customer (such as via wireless communication or data transmission of personal articles insurance-related information from the processor (or associated transmitter) to the mobile device or computing device of the customer) for review, approval, and/or modification by the customer to facilitate more accurate pricing and/or pricing that is a more accurate reflection of risk for personal articles insurance policies. The computer system may include additional, less, or alternate functionality, including that discussed elsewhere herein.

For instance, the one or more processors may be further configured to: build and/or update an inventory or list of personal belongings of the customer from the digital image data of personal articles; and/or generate or provide personal articles insurance recommendations to the customer based upon the inventory or list of personal belongings, such as recommendations to increase or decrease personal articles insurance coverages, deductibles, and/or liabilities. The one or more processors may be further configured to: build and/or update an inventory or list of personal belongings of the customer from the digital image data of personal articles; and/or use the inventory or list of personal belongings, and/or estimations of value for each of the personal belongings in the inventory or list that are generated using OR and/or OCR techniques performed on the digital image data of personal articles, to handle or address insurance claims (e.g., estimate replacement costs for damaged personal articles) resulting from insurance-related events, such as in the cause of house fire that results in a partial or total loss of the personal belongings.

The digital image data may be representative of at least one photograph of the at least one personal article and at least one of: an appraisal of the at least one personal article, a purchase receipt for the at least one personal article, a certification associated with the at least one personal article, or a written description of the at least one personal article. The one or more processors may be further configured to analyze the digital image data of the personal articles to (1) cross validate an appraisal of a personal article; (2) determine whether multiple documents match the personal article; (3) determine whether multiple images of the personal article match; (4) validate attributes of the personal article for fraud; (5) determine whether the digital image data is representative of an internet photo; (6) determine whether a date associated with digital image data associated with a picture of the at least one personal article is dated prior to a purchase receipt for the at least one personal article; (7) determine whether a same photo of the at least one personal article was previously submitted; (8) determine whether a geo-tagged location differs from an insurance customer location during purchase of a personal article; and/or (9) determine potential insurance discounts; and/or (10) identify prior insurance claims related to the personal article.

The one or more processors may be configured to receive insurance customer answer data, wherein the insurance customer answer data is representative of answers, provided by an insurance customer, and/or wherein the questions are representative of at least one of: whether a personal article is kept in a safe, whether the personal article is kept in a vault, how long the personal article is kept in a safe, how long the personal article is kept in a vault, whether the personal article is gem-printed, whether the personal article is GIA certified, whether the personal article is EGL certified, whether insurance coverage for the personal article is desired when the personal article is unattended, whether the insurance customer has an alarm certificate, whether the personal article is for professional use, and/or whether the personal article is for non-professional use.

In another aspect, a computer system configured for handling personal articles insurance claims may be provided. The computer system may include one or more processors configured to: (1) receive a data transmission or wireless communication including digital image data of, and/or associated with, one or more personal articles of a customer, the digital image data of, and/or associated with, one or more personal articles being generated by a mobile device or computing device of the customer and transmitted to the processor; (2) identify a type and/or characteristic of each of the one or more personal articles by employing object recognition (OR) and/or optical character recognition (OCR) techniques on the digital image data of, and/or associated with, the one or more personal articles; (3) estimate a value for each of the one or more personal articles based upon the type and/or characteristic of each respective personal article that is determined from the OR and/or OCR techniques employed on the digital image data; (4) receive a data transmission or wireless communication, such as from the mobile device or computing device of the customer, and/or other notification from the customer of a personal articles insurance policy claim (associated with a personal articles insurance policy covering the personal articles) and/or an insurance-related event (e.g., hurricane, flood, fire, tornado, etc.) that has led to a partial or total loss of one or more personal articles covered by a personal articles insurance policy; and/or (5) handle or address the personal articles insurance claim (such as by estimating replacement cost or values) utilizing the estimated values of damaged or lost personal articles that have been estimated from the OR and/or OCR techniques employed on the digital image data of, and/or associated with, the one or more personal articles to facilitate more efficient and/or more accurate personal articles insurance claim handling.

In another aspect, a computer system configured for automatically inventorying personal articles for insurance-related purposes may be provided. The computer system may include one or more processors configured to: (1) receive a data transmission or wireless communication including digital image data of, and/or associated with, one or more personal articles of a customer, the digital image data of, and/or associated with, the one or more personal articles being generated by a mobile device or computing device of the customer and transmitted to the processor; (2) identify a type and/or characteristic of each personal article by employing object recognition (OR) and/or optical character recognition (OCR) techniques on the digital image data of, and/or associated with, the one or more personal articles; (3) estimate a value for each of the one or more personal articles based upon the type and/or characteristic of each respective personal article that is determined from the OR and/or OCR techniques employed on the digital image data of, and/or associated with, each of the one or more personal articles; (4) generate, update, or adjust a personal articles inventory of personal belongings for the customer based upon, and/or that includes, (i) the type and/or characteristic of each personal article; and/or (ii) the estimated value of the one or more personal articles that is estimated from the OR and/or OCR techniques employed on the digital image data; and/or (5) cause an insurance-related action to be performed based upon the personal articles inventory to facilitate more accurate insurance quoting, pricing, and/or claim handling. The insurance-related action may be handling, addressing, and/or estimating, via the one or more processors, a personal articles insurance claim associated with one or more of the personal articles being damaged or lost based upon the personal articles inventory of personal belongings for the customer generated using OR and/or OCR techniques; and/or (i) the type and/or characteristic of each personal article; and/or (ii) the estimated value of the one or more personal articles that is estimated from the OR and/or OCR techniques employed on the digital image data.

In another aspect, a computer system configured for automatically inventorying personal articles for insurance-related purposes may be provided. The computer system include one or more processors configured to: (1) receive a data transmission or wireless communication including digital image data of, and/or associated with, one or more personal articles of a customer, the digital image data of, and/or associated with, the one or more personal articles being generated by a mobile device or computing device of the customer and transmitted to the processor; (2) identify or verify a type and/or characteristic of each personal article by employing object recognition (OR) and/or optical character recognition (OCR) techniques on the digital image data of, and/or associated with, the one or more personal articles; (3) receive another or the same data transmission or wireless communication including additional digital image data of, and/or associated with, an appraisal, receipt, or other acceptable documentation tending to establish or prove a current value or worth, or replacement cost, of a corresponding personal article, the additional digital image data of, and/or associated with, the appraisal, receipt, or other acceptable documentation being generated by a mobile device or computing device of the customer and transmitted to the processor; (4) generate a quote for a personal articles insurance policy that covers the one or more personal articles based upon the current value or worth of the one or more personal articles as established or evidenced by the additional digital image data of, and/or associated with the appraisal, receipt, or other acceptable documentation (and/or computer analysis thereof, such as via OR or OCR techniques); and/or (5) cause the quote for the personal articles insurance policy to be transmitted and displayed on a mobile device of the customer for their review, modification, or approval to facilitate providing more accurate or appropriate levels of personal articles insurance coverage to customers.

The fore-going computer systems (and processors) may include additional, less, or alternate functionality, including that disclosed elsewhere herein, and may be implemented via computer-executable instructions stored on non-transitory computer-readable medium or media.

This detailed description is to be construed as exemplary only and does not describe every possible embodiment, as describing every possible embodiment would be impractical, if not impossible. One could implement numerous alternate embodiments, using either current technology or technology developed after the filing date of this application.

1. A computer implemented method for automatically generating personal articles insurance data, the method comprising:
receiving, at a processor of a computing device, digital image data from an electronic device, in response to the processor executing a digital image data receiving module, wherein the digital image data is representative of a plurality of photographs of at least one personal article, wherein the digital image data includes a date/time stamp and a geo-tag;
generating, using a processor of a computing device, personal articles information data, based upon the digital image data, in response to the processor executing a personal articles information data recognition module, wherein the personal articles information data is representative of identifying characteristics of the at least one personal article, a date/time stamp, and a geo-tag, and wherein the date/time stamp and the geo-tag are extracted from the digital image data;
authenticating, using a processor of a computing device, a personal article based on a comparison of the personal articles information data with the digital image data, wherein the authenticating is representative of at least one of: whether the digital image data indicates use of an internet photo, whether the digital image data is detected to be prior to a date on a purchase receipt for the personal article, whether the digital image data is detected to be a prior submission of a same photo of the personal article, cross validating an appraisal of the personal article, determining whether multiple documents match the personal article, determining whether multiple images of the personal article match, or validating attributes of the personal article for fraud; and
generating, using a processor of a computing device, personal articles insurance data, based upon the personal articles information data and the authentication of the personal article, in response to the processor executing a personal articles insurance data generation module to facilitate providing personal articles insurance to insurance customers.

2. The method of claim 1, wherein the digital image data is further representative of an image of alpha-numeric text related to the at least one personal article.

3. The method of claim 2, wherein the personal articles information data recognition module is an optical character recognition module that extracts personal article information data from the image of the alpha-numeric text.

4. The method of claim 1, wherein the digital image data is representative of an appraisal of the at least one personal article.

5. The method of claim 4, wherein the personal articles information data recognition module is an object recognition module that extracts personal articles information data from the appraisal of the at least one personal article.

6. The method of claim 1, further comprising:
receiving, at a processor of a computing device, insurance customer answer data, wherein the insurance customer answer data is representative of answers, provided by an insurance customer, and wherein the questions are representative of at least one of: whether the personal article is kept in a safe, whether the personal article is kept in a vault, how long the personal article is kept in a safe, how long the personal article is kept in a vault, whether the personal article is gem-printed, whether insurance coverage for the personal article is desired when the personal article is unattended, whether the insurance customer has an alarm certificate, whether the personal article is for professional use, or whether the personal article is for non-professional use; and
the personal articles insurance data is further based upon the insurance customer answer data.

7. A computer system for automatically generating personal articles insurance data, the system comprising:
a digital image data receiving module stored on a memory that, when executed by a processor of a computing device, causes the processor to receive digital image data from an electronic device, wherein the digital image data is representative of a photograph of at least one personal article, wherein the digital image data includes a date/time stamp and a geo-tag;
a personal articles information recognition module stored on a memory that, when executed by a processor of a computing device, causes the processor to generate personal articles information data based upon the digital image data, wherein the personal articles information data is representative of identifying characteristics of the at least one personal article, a date/time stamp, and a geo-tag, and wherein the date/time stamp and the geo-tag are extracted from the digital image data;
a personal article location verification module stored on a memory that, when executed by a processor of a computing device, causes the processor to determine verify a location of the personal article based upon at least one of: whether the digital image data indicates use of an internet photo, whether the digital image data is detected to be a prior submission of a same photo of the personal article, cross validating an appraisal of the personal article, whether multiple documents match the personal article, whether multiple images of the personal article match, or validating attributes of the personal article for fraud; and
a personal articles insurance data generation module stored on a memory that, when executed by a processor of a computing device, causes the processor to generate personal articles insurance data based upon the verified location of the at least one personal article.

8. The system of claim 7, wherein the digital image data is representative of at least one of: an appraisal of the at least one personal article, a purchase receipt for the at least one personal article, a certification associated with the at least one personal article, or a written description of the at least one personal article.

9. The system of claim 8, wherein the personal articles information data is further used for at least one of: cross validating an appraisal of the personal article, determining whether multiple documents match the personal article, determining whether multiple images of the personal article match, validating attributes of the personal article for fraud, determine whether the digital image data is representative of an internet photo, determine whether a date associated with digital image data associated with a picture of the at least one personal article is dated prior to a purchase receipt for the at least one personal article, determine whether a same photo of the at least one personal article was previously submitted, determine potential insurance discounts, and identify prior insurance claims related to the personal article.

10. The system of claim 7, further comprising:
an insurance customer answer data receiving module stored on a memory that, when executed by a processor of a computing device, causes the processor to receive insurance customer answer data, wherein the insurance customer answer data is representative of answers, provided by an insurance customer, and wherein the questions are representative of at least one of: whether the personal article is kept in a safe, whether the personal article is kept in a vault, how long the personal article is kept in a safe, how long the personal article is kept in a vault, whether the personal article is gem-printed, whether insurance coverage for the personal article is desired when the personal article is unattended, whether the insurance customer has an alarm certificate, whether the personal article is for professional use, or whether the personal article is for non-professional use; and
the personal articles insurance data is further based upon the insurance customer answer data.

11. The system of claim 10, further comprising:
a personal articles information validation module stored on a memory that, when executed by a processor of a computing device, causes the processor to validate the insurance customer answer data based upon the personal articles information data.

12. A non-transitory computer-readable medium storing instructions that, when executed by a processor of a computing device, cause the processor to automatically generate personal articles insurance data, the non-transitory computer-readable medium comprising:
a digital image data receiving module that, when executed by a processor of a computing device, causes the processor to receive digital image data from an electronic device, wherein the digital image data is representative of a photograph of at least one personal article, wherein the digital image data includes a date/time stamp and a geo-tag;
a personal articles information recognition module that, when executed by a processor of a computing device, causes the processor to generate personal articles information data based upon the digital image data, wherein the personal articles information data is representative of identifying characteristics of the at least one personal article, a date/time stamp, and a geo-tag, and wherein the date/time stamp and the geo-tag are extracted from the digital image data;
a personal article location verification module that, when executed by a processor of a computing device, causes the processor to determine at least one of: whether the digital image data indicates use of an internet photo, whether the digital image data is detected to be prior to a date on a purchase receipt for the personal article, whether the digital image data is detected to be a prior submission of a same photo of the personal article, cross validating an appraisal of the personal article, whether multiple documents match the personal article, whether multiple images of the personal article match, or validating attributes of the personal article for fraud; and
a personal articles insurance data generation module that, when executed by a processor of a computing device, causes the processor to generate personal articles insurance data based upon the personal articles information data and the determination as to whether the geo-tagged location of the at least one personal article differs from the insurance customer location during purchase of the at least one personal article to facilitate providing personal articles insurance to insurance customers.

13. The non-transitory computer-readable medium of claim 12, further comprising:
a digital image data transmission module that, when executed by a processor of a client device, causes the processor to transmit digital image data from the processor of the client device to a processor of a remote computing device.

14. The non-transitory computer-readable medium of claim 13, wherein the personal articles information recognition module and the personal articles insurance data generation module are executed by a processor of a remote computing device; and
further comprising a personal articles insurance data transmission module that, when executed by the processor of the remote computing device, causes the processor of the remote computing device to transmit personal articles insurance data to the processor of the client device.

15. The non-transitory computer-readable medium of claim 12, further comprising:
a personal articles information data transmission module that, when executed by a processor of a client device, causes the processor of the client device to transmit personal articles information data from the processor of the client device to a processor of a remote computing device.

16. The non-transitory computer-readable medium of claim 15, wherein the personal articles insurance data generation module is executed by a processor of a remote computing device; and
further comprising a personal articles insurance data transmission module that, when executed by the processor of the remote computing device, causes the processor of the remote computing device to transmit personal articles insurance data to the processor of the client device.

17. The non-transitory computer-readable medium of claim 12, further comprising:
a personal articles insurance quote generation module that, when executed by a processor of a computing device, causes the processor to generate personal articles insurance quote data based upon the personal articles insurance data.

18. The non-transitory computer-readable medium of claim 17, further comprising:
a personal articles insurance quote acceptance module that, when executed by a processor of a computing device, causes the processor to generate personal articles insurance quote acceptance data in response to a user accepting a quote for personal articles insurance.

19. The non-transitory computer-readable medium of claim 12, wherein the digital image data is further representative of an image of alpha-numeric text related to the at least one personal article, and wherein the personal articles information recognition module includes an optical character recognition module that extracts personal article information from the image of the alpha-numeric text.

20. The non-transitory computer-readable medium of claim 12, wherein the digital image data is representative of an appraisal of the at least one personal article, and wherein the personal articles information recognition module includes an object recognition module that extracts personal article information from the photograph of the at least one personal article.
